(19) United States
(12) Patent Application Publication
(10) Pub. No.: US 2012/0099957 A1
(43) Pub. Date: Apr. 26, 2012

(54) Apparatus for Curb Removal and Transport

(76) Inventors: Patrick A. BURNETT, Crete, IL (US); William B. Michaels, Monee, IL (US)

(21) Appl. No.: 12/908,240

(22) Filed: Oct. 20, 2010

(51) Int. Cl. B66C 1/44; B66C 23/36

(52) U.S. Cl. 414/741; 414/738

(57) ABSTRACT

An apparatus such as an attachment for a skid steer used to remove and transport curb segments may include a fork configured to drive into the ground behind the curb. The apparatus also may include a curb restrainer configured to engage the upper side of the curb. Each of the forks may be tapered to slide into the ground more easily, and each bearing surface may be removably attached to the apparatus for easy repair or replacement. Additionally, the curb restrainer may both translate and rotate to adjust for various curb thicknesses in order to position the restrainer against the top of the curb, preferably in the curve of the curb. By limiting the amount of the apparatus that penetrates the ground, the apparatus provides a method of removing curbs that is quick and efficient, resulting in minimal disturbance to the ground and easier preparation for pouring a new curb.

### BACKGROUND OF THE INVENTION

1. Field of the Invention

The present invention is directed to an apparatus for removing and transporting portions of concrete or other paving, specifically for removing and transporting sections of curbing.

2. Description of the Related Art

Various methods for removing and transporting sections of curb exist. One end of the spectrum involves jackhammering the section into smaller pieces and manually picking up and carrying the pieces to a second location such as a waste bin or a bin connected to a dump truck or semi. While this method may minimize the disturbance to the surrounding area, it is labor and time intensive, which may lead to decreased productivity and increased cost. In addition, this process may render the curb sections unusable for many applications, since it may result in breaking the sections into several smaller pieces to better manage the weight.

Less manual methods also exist. For example, a small mechanized machine, including, e.g., a skid steer sold under the trademark BOBCAT, may be used with a bucket attachment to dig behind the curb section. Due to the weight of the skid steer, this process often results in substantial destruction of the landscaping surrounding the curb and of the earthen foundation under the curb. Particularly with soft soil, the wheels or tracks of a skid steer may create ruts in the parkway or other landscaped area as the skid steer moves toward and away from the curb and adjusts position when attempting to remove the curb portions. The bucket attachment also may significantly disturb the ground underneath the curb, requiring substantial preparation and grading to ready the area for a new curb.

Alternatively, a backhoe may be used to dig behind and underneath the curb section. Unlike the skid steer, the backhoe may be able to operate from a position on the street, so that its tracks may not disturb the ground in an area proximate the curb. In this position, as the bucket moved inward toward the operator, the backhoe may dislodge and scoop up the curb section. However, this may be a rather rough process, such that the bucket also may substantially disturb and remove the earth around the curb.

Still another method of removing curb portions may be to penetrate the ground under the curb with one or more long forklift-type forks that can pivot relative to the ground. These forks may have to enter the ground a significant distance away from the curb in order to embed deep enough to get under the curb section. As in the other cases, as they then are pivoted up towards the portion, they may disturb and remove a substantial portion of that foundation. In addition, the curb portion may be relatively unstable when lifted to significant heights, such as when raising it over the edge of the bin connected to a semi.

What is needed is an apparatus that overcomes the drawbacks described above.

### BRIEF SUMMARY OF THE INVENTION

In one aspect, an apparatus for removing a curb segment may comprise an apparatus for removing a curb segment, the apparatus having: a base portion releasably coupled to a portable transportation device; a fork extending generally downward from the base portion, the fork having a distal end; a bearing surface proximate the distal end of the fork, the bearing surface configured to engage an underside of the curb segment; a curb restrainer configured to engage an upper side of the curb segment; and a hydraulic system configured to position the curb restrainer. In one embodiment, the apparatus may be a construction vehicle such as a skid steer, and the hydraulic system may operatively couple to a hydraulic system of the portable transportation system.

The apparatus additionally may include at least one translatable guide operatively coupled to the base portion and curb restrainer and at least one piston also operatively coupled to the base portion and curb restrainer. In addition, the apparatus may include a plurality of translatable guides and a plurality of pistons operatively coupled to both the base portion and the curb restrainer. The translatable guide may comprise a base portion and an insert, and the insert may be adjustable among a plurality of discrete positions. In one example, the curb restrainer may be a roller.

In another aspect, an attachment for a skid steer may comprise: an attachment plate configured to couple to the skid steer; at least one fork extending generally downward from the attachment plate; at least one bearing surface proximate a distal end of the fork; at least one tapered tine proximate a distal end of the fork; and a telescoping curb restrainer rotatably, operatively coupled to the attachment plate. The curb restrainer may be coupled to at least one piston, and that piston may be operatively coupled to the attachment plate. In addition, the curb restrainer also may be coupled to at least one telescoping guide, and that telescoping guide may be operatively coupled to the attachment plate. Moreover, the piston and the telescoping guide may be rotatable with respect to the attachment plate.

The attachment may include additional features. For example, the hydraulic system may operatively couple to the telescoping curb restrainer. In addition, the attachment may include a first cover and a second cover disposed proximate the first cover. The covers may overlap, and the first cover may move relative to the second cover when said hydraulic system extends and retracts the telescoping curb restrainer, i.e., one or both of the covers may move, provided there is relative movement between covers.

The at least one bearing surface may be releasably coupled to the least one fork. Moreover, the holder may be proximate the distal end the fork, and the holder may be configured to hold a wear bar, such as when the wear bar comprises the bearing surface. The wear bar may include at least one prong, and the one holder may include at least one recess configured to receive the prong.

In still another aspect, an apparatus for removing a curb segment may include: a fork having a proximal end and a tapered, distal end; a wear bar having a bearing surface substantially perpendicular to the fork; a wear bar holder proximate the distal end of the fork; a telescoping and rotating curb restrainer; and a hydraulic ram coupled to the curb restrainer; where the wear bar may include a prong and the wear bar holder may include a recess configured to receive the prong. The wear bar holder may include at least one tine extending below the distal end of the fork, and the tine may taper from proximate the bearing surface toward a distal end of the tine. The apparatus also may include a second hydraulic ram coupled to the curb restrainer. Additionally, the curb restrainer may comprise a roller mounted on a shaft, and the hydraulic rams may couple to the shaft proximate opposite ends of the roller.

These and other features and advantages are evident from the following description of the present invention, with reference to the accompanying drawings.

### BRIEF DESCRIPTION OF THE SEVERAL VIEWS OF THE DRAWINGS

FIG. 1 is a perspective view of an apparatus for removing and transporting sections of curb.

FIG. 2 is an exploded view of the apparatus of FIG. 1

FIG. 3 is a perspective view of the apparatus of FIG. 1, including a curb section removed from the ground.

FIG. 4 is a perspective view of the apparatus of FIG. 1, attached to a skid steer, and shown in an elevated configuration for dumping a removed curb section.

FIG. 5 is a side view of the apparatus of FIG. 1.

FIG. 6 is a side view of the other side of the apparatus of FIG. 1.

FIG. 7 is a bottom view of the apparatus of FIG. 1.

FIG. 8 is a top view of the apparatus of FIG. 1.

FIG. 9 is a front view of the apparatus of FIG. 1.

FIG. 10 is a rear view of the apparatus of FIG. 1

FIG. 11 is a side view of a second embodiment of an apparatus for removing and transporting sections of curb, in which the ground-penetrating fork is inclined relative to the attachment plate and to the ground.

FIG. 12 is a side view of the other side of the apparatus of FIG. 11.

FIG. 13 is a perspective view of the apparatus of FIG. 11.

### DETAILED DESCRIPTION

An apparatus 1 for removing and transporting sections of curb or other paving may be an attachment to a skid steer, compact track loader, all-wheel steer loader or another type construction equipment, including e.g., a loader sold under the trademark BOBCAT or an excavator sold under the trademark GRADALL. Although the apparatus is described herein as an attachment for a skid steer 90, the apparatus may be modified to attach to these other types of equipment without diverging from the scope of the invention, such as by modifying attaching plate 2 to comply with the attachment requirements for that equipment. For the sake of description, apparatus 1 may be referred to herein as a “curber.”

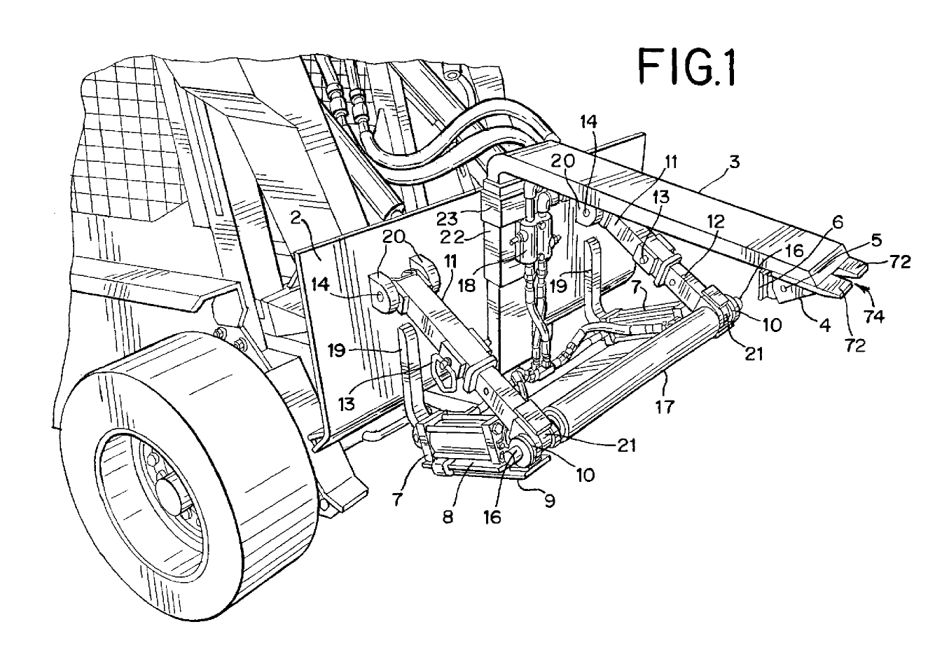

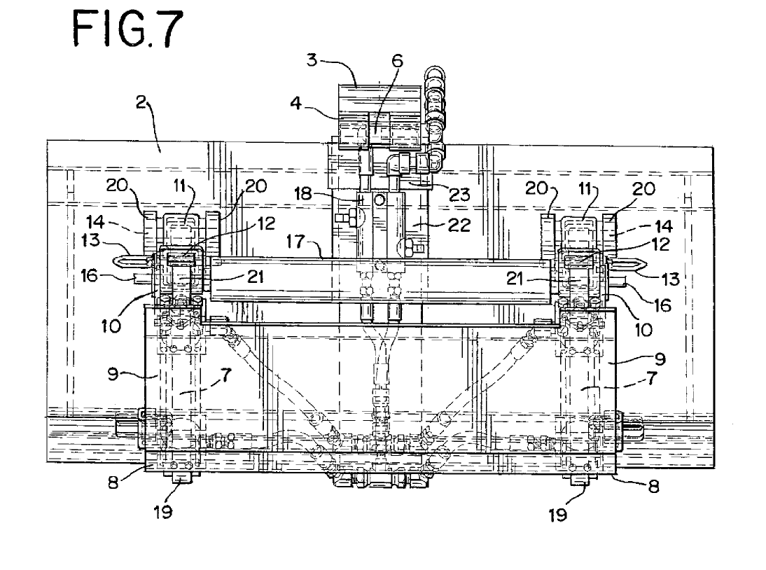

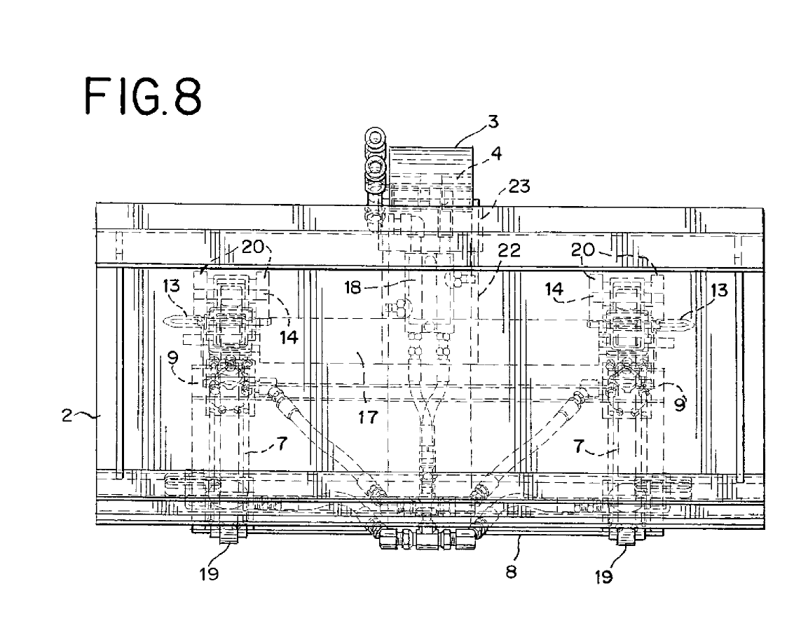

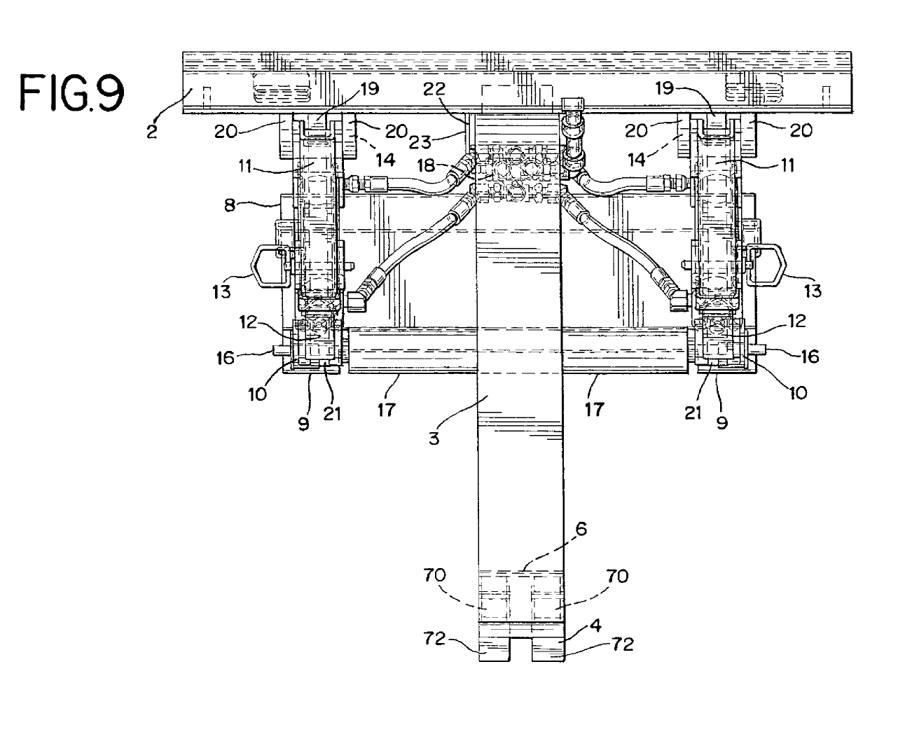

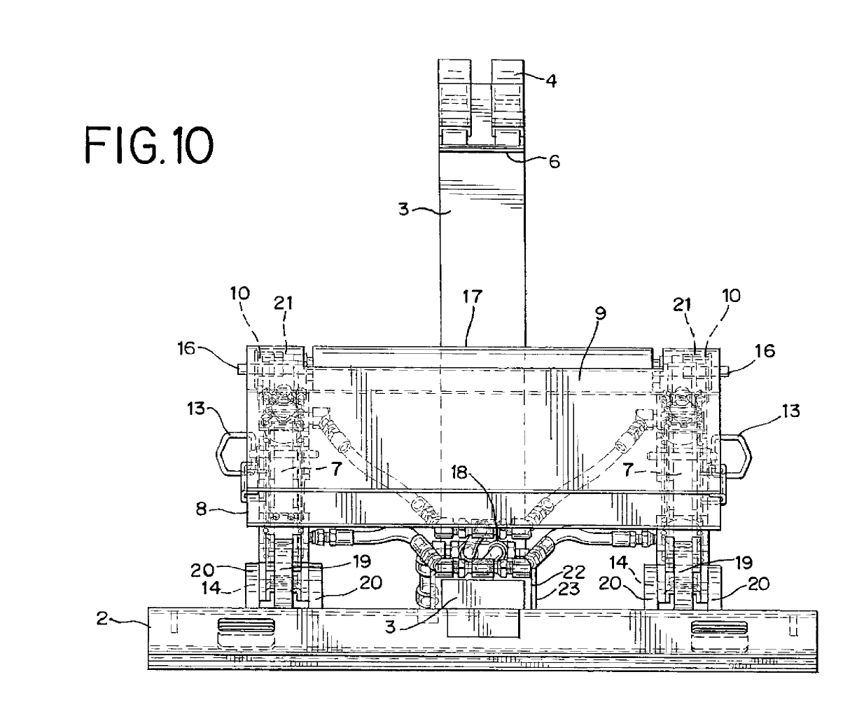

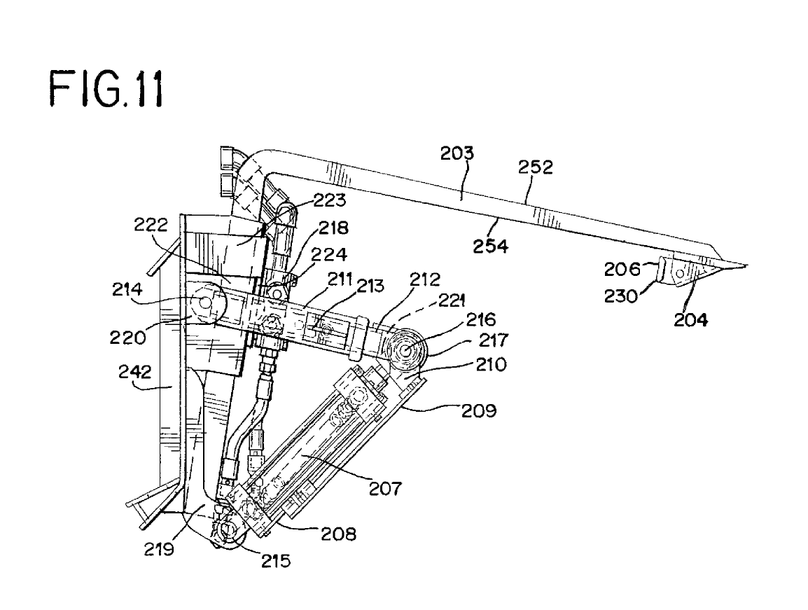

As seen in FIG. 1 and the various orthogonal views of FIGS. 7-10, skid steer 90 may include a plurality of prongs 92 and a locking mechanism 94. Attachment plate 2 may include a flange 34 disposed at substantially the same angle as prongs 92, so that prongs 92 may abut flange 34 when apparatus is mounted to skid steer 90. Plate 2 also may include bearing plate 36 for releasable engagement with locking mechanism 94. Bearing plate 36 may be inclined at an angle similar to or substantially the same as flange 34 or, preferably, at an angle to maximize engagement with bearing plate 36. Attachment plate 2 may have a first side 40 and second side 42 that may extend between flange 34 and bearing plate 36. Sides 40, 42 may be aligned with respective edges of attachment plate 2, or sides 40, 42 may be spaced inward from edges, e.g., separated by a distance slightly larger than distance between prongs 92. Flange 34 and bearing plate 36 may extend substantially along a width of plate 2, from edge to edge, preferably at least from side 40 to side 42. Flange 34 may be attached to attachment plate 2, e.g., by welding to base of plate and to sides 40, 42.

Curber 1 may include at least one, and potentially a plurality, of picking forks 3. Each fork 3 may have a laterally extending portion 51 that may be connected to attachment plate 2 and a longer, downwardly extending portion 53 that terminates at distal end 50. Laterally extending portion may be fixedly coupled to attachment plate, e.g., via fasteners extending through both fork 3 and attachment plate 2 and/or via welding. Additionally or alternatively, curber 1 may include support bracket 22 for holding fork 3. Support bracket 22 may be a generally U-shaped bracket and may have a series of inner surfaces sized substantially similarly to a respective series of surfaces on laterally extending portion of fork 3. Bracket 22 may be welded to attachment plate 2, integrally formed with plate 2, or otherwise configured to be disposed on attachment plate 2. Bracket 22 also may extend a significant portion of the length of attachment plate 2, e.g., at least about half the length. As such, bracket 22 may strengthen connection between fork 3 and attachment plate 2, and it may assist in distributing weight of curb segments from fork 3 to attachment plate 2 while helping minimize the occurrence of stress concentrations between fork 3 and attachment plate 2.

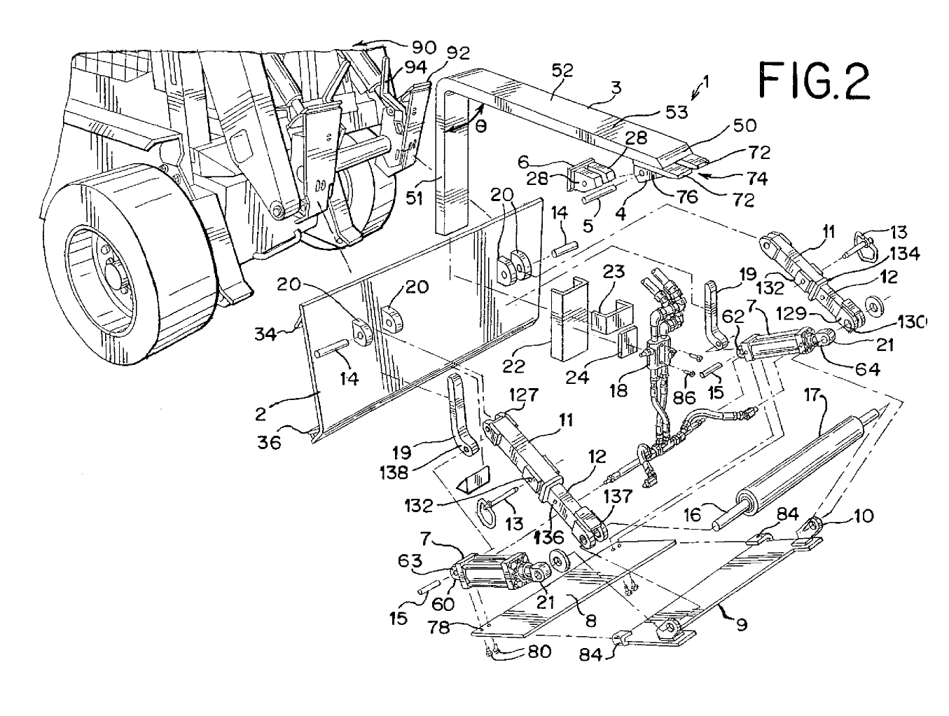

As seen in FIGS. 1 and 2, curber 1 also may include a support bracket band 23, which may be disposed over both fork 3 and bracket 22. Similar to bracket 22, band 23 may be welded, integrally formed with, or otherwise configured to be disposed on attachment plate 2. Band 23 also may include one or more openings configured to receive fasteners that may pass through band 23, fork 3, and possibly bracket 22. In addition to further securing fork 3 to attachment plate 2, these openings may assist in aligning fork 3, e.g., if one fork needs to be replaced with another fork.

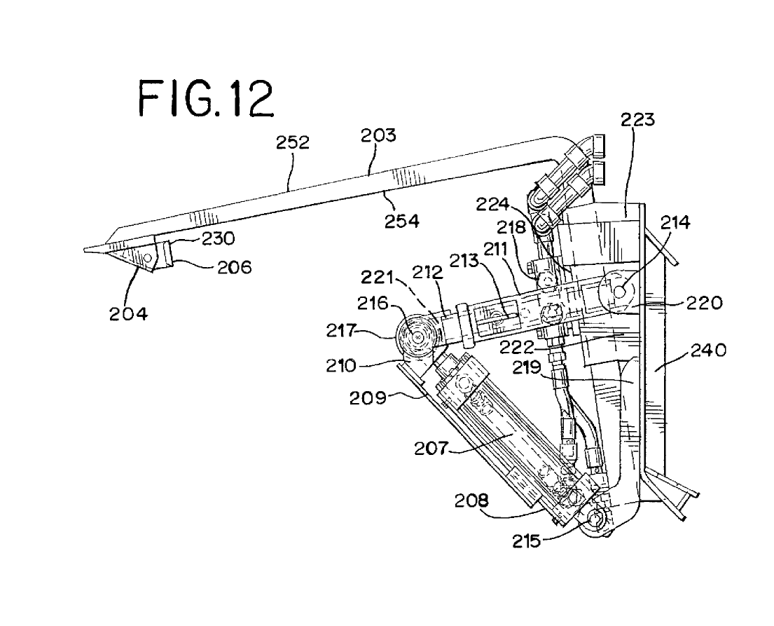

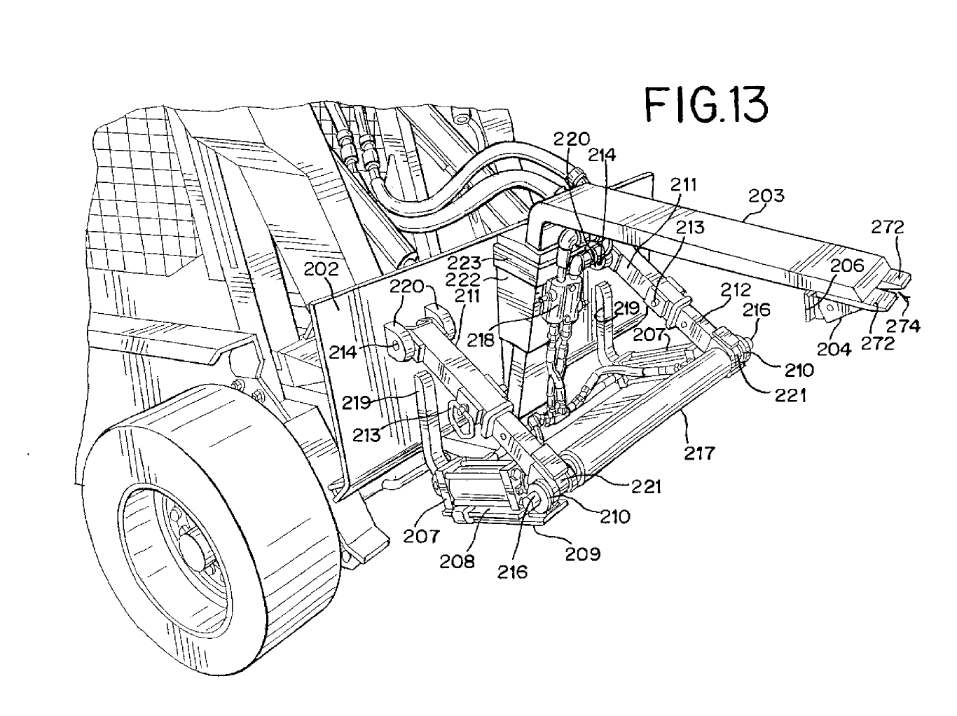

Turning to FIGS. 11-13, a second fork configuration is shown. Elements in this embodiment are similar to the embodiment described above, with 200s prefixes being used for the reference numerals. In this embodiment, as in the previous embodiment, laterally extending portion 251 and downwardly extending portion 253 may remain generally perpendicular to one another. Instead of running generally parallel to attachment plate 202, however, laterally extending portion 251 may be declined with respect to attachment plate 202, causing downwardly extending portion 253 to be generally angled inward toward the skid steer or toward curb restrainer 217.

Laterally extending portion 251 may form an angle, θ, with attachment plate 202 that preferably is slightly acute. For example, θ may be between about 45 degrees and about 90 degrees, preferably between about 60 degrees and about 85 degrees, and in one embodiment, about 80 degrees. Because laterally extending portion 251 and downwardly extending portion 253 may remain generally perpendicular, this may also represent the angle that downwardly extending portion 253 makes relative to a plane extending upward from the ground.

In order to maintain the decline between laterally extending portion 251 and attachment plate 202 at a generally constant angle, curber 1 may include one or more wedges between laterally extending portion 251 and attachment plate 202. Each wedge may extend along at least a portion of attachment plate 202. Additionally, width of wedge may vary. For example, a single wedge having a width similar to width of fork 203 may be employed to provide a single large ramp surface along which laterally extending portion 251 may bear. Similarly, a plurality of narrower wedges may be employed. These narrower wedges may be spaced along fork 203, e.g., at each edge of fork and/or in a central location between edges. In either event, wedges may be fixed to attachment plate, e.g., via welding. Wedges also may be attached to fork 203, e.g., also via welding.

To accommodate wedges, bracket 222 and band 223 may be modified. For example, bracket 222 and band 223 may be declined at a substantially equal angle, θ, as laterally extending portion 251.

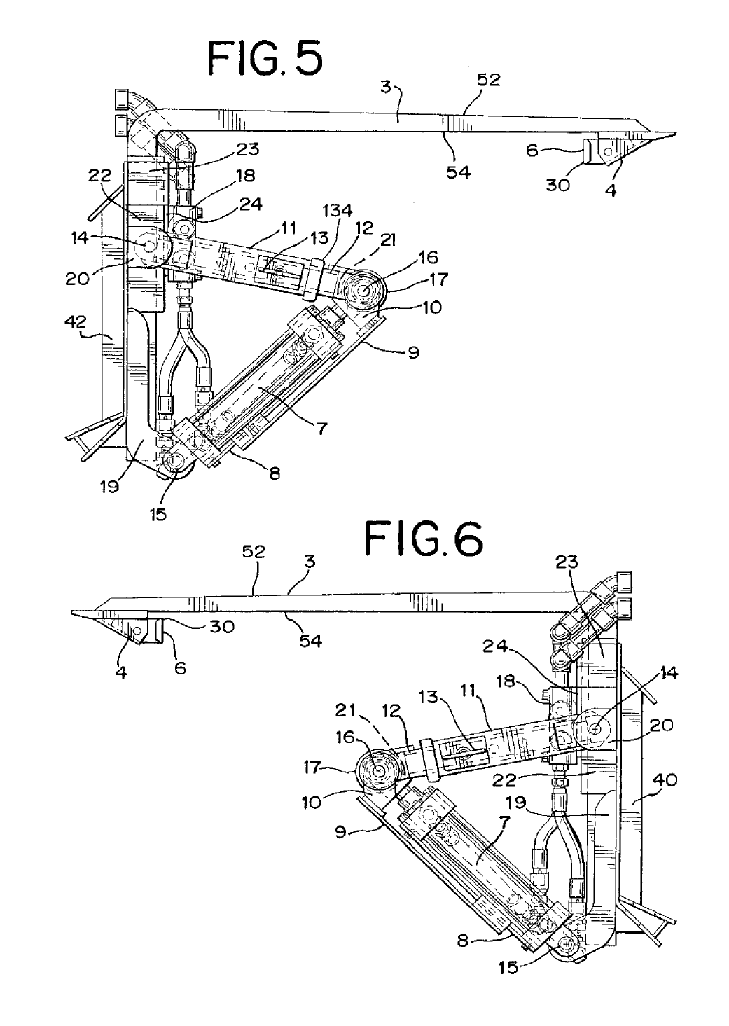

In still another embodiment, the laterally extending portion of the fork may remain generally parallel to the attachment plate, as in FIGS. 1-10. However, the downwardly extending portion may be inclined relative to the attachment plate and/or a plane extending upward from the ground, as in FIGS. 11-13. In this embodiment, instead of being generally perpendicular, the laterally extending portion of the fork and the downwardly extending portion may form angle θ. In yet another embodiment, the laterally extending portion may remain generally parallel to the attachment plate, and the part of the downwardly extending portion proximate the laterally extending portion may remain generally perpendicular to the laterally extending portion. In this embodiment, the downwardly extending portion may include an inward bend, forming angle θ between that inwardly bent portion and a plane perpendicular to the ground.

Returning to the embodiment of FIGS. 1-2 (although these features may apply similarly to the other embodiments discussed above), distal end 50 may be tapered downward from outer face 52 to inner face 54 in order to form a blade-like surface for cutting through soil around curb portion. Fork 3 also may include or be coupled to an inwardly extending wear bar holder 4. Holder 4 may include one or more downwardly extending tines 72. As seen in FIGS. 1 and 2, each holder 4 may include a pair of tines 72 with a gap 74 therebetween. Like distal end 50 of fork 3, tines 72 may be tapered. Combined tapers of tines 72 and distal end 50 may provide fork 3 with a generally V-shaped wedge, which may reduce resistance and ease driving of fork 3 into the ground.

Turning to the phantom line portion of FIG. 9, holder 4 also may include one or more recesses 70. Recesses 70 may be generally aligned with, or may be formed within, tines 72. Curber 1 may include one or more wear bars 6 on which curb portion may rest during removal and transport. Returning to FIG. 2, wear bar 6 may include a plurality of prongs 28 configured to be inserted into recesses 70 of holder 4. In addition, holder 4 may include one or more openings, e.g., in side 76 of holder 4. Openings may be configured to receive wear bar pin 5 for removably coupling wear bar 6 to holder 4. In one embodiment, wear bar 6 also may include aligned openings such that pin 5 may pass through wear bar holder 4 and against or into wear bar 6. Pin 5 may be sized for frictional engagement with holder 4 and/or wear bar 6. Alternatively, pin 5 may be threaded, as may be one or more of holder 4 and wear bar 6.

Preferably, wear bar 4 may need replacement or repair significantly more frequently than fork 3. As such, pin 5 allows for easy removal and/or replacement of wear bar 4 without having to disassemble more of curber 1.

Each wear bar 4 may include a bearing surface 30 on which a portion of the curb segment may rest when the segment is removed from the ground. Bearing surface 30 also may allow for the transmission of a generally vertical force to separate curb segment from foundation. Bearing surface 30 may be generally flat and may extend inward, substantially perpendicular to fork 3. Preferably, however, bearing surface 30 may be grooved, etched, or otherwise textured in order to increase surface area and frictional engagement with underside of curb segment. Bearing surface 30 may have a width substantially similar to width of fork 3, e.g., between about 4 inches and about 10 inches, preferably about 6 inches. Additionally, bearing surface 30 may extend inward between about 1 inch and about 8 inches, preferably between about 1 inch and about 4 inches, and in one embodiment, about 2 inches.

In the embodiment shown in FIG. 1, curber 1 includes a single fork 3. Additional forks may be included to provide additional penetrating tines to aid in penetrating under the curb and additional bearing surfaces for distributing and balancing the weight of the curb. In the event that multiple forks 3 are used, forks 3 preferably may be distributed generally symmetrically about a centerline of attachment plate 2.

Fork 3 and holder 4 may be made of a strong, durable material such as high strength, high carbon steel. Added strength may allow fork 3 and holder 4 to drive through compacted soil, rocks, concrete fragments, etc., without cracking, breaking or deforming substantially.

While wear bar 6 may engage an underside of curb, curber 1 also may include a roller 17 configured to engage upper surface of curb, preferably proximate the bend in the curb. Roller 17 may have a diameter selected to increase engagement with both the generally horizontal and the generally vertical portions of the curb. For example, roller diameter may be between about 1 inch and about 10 inches, preferably between about 2 inches and about 6 inches, and in one embodiment, about 3 inches.

Roller 17 also may have a length configured to hold and stabilize curb section. For example, curber 1 may be able to lift curb sections between about 1 foot and about 10 feet wide. In the event that a single roller 17 is used, roller 17 may be between about 1 foot and about 5 feet long, preferably between about 1 foot and about 3 feet long, and in one embodiment, about 2 feet long. If curber 1 includes more than one fork 3 and/or more than one roller 17, each roller may be shorter than if only a single roller 17 were used.

Roller 17 may be connected to a generally concentric shaft 16, which may protrude from each end of roller 17. As seen in FIG. 2, shaft 16 may couple to or operatively engage one or more roller guides 11. Curber 1 preferably includes a plurality of roller guides 11, e.g., one guide 11 coupled to each end of shaft 16. Guides 11 preferably are substantially similar to one another, so the following description may apply to both guides 11.

Proximal portion of insert 12 may be configured to fit inside guide 11. In addition, distal end 137 of insert 12 may include one or more couplers such as mounting ears 129 with openings 130 for operatively engaging insert 12 with roller shaft 16. Couplers preferably join insert 12 with shaft 16, while still allowing insert 12 and shaft 16 to rotate relative to one another.

Roller guide 11 may include or slidably couple to a telescoping insert 12 to vary distance between attachment plate 2 and roller 17 or wear bar 6 and roller 17, allowing curber 1 to accommodate curb sections of varying thickness. Insert 12 may be disposed inside roller guide 11. As insert 12 is lengthened, distance between wear bar 6 and roller 17 decreases. Preferably, insert 12 is adjusted to a distance that results in roller 17 being located proximate bend in curb.

Roller guide 11 may include at least one opening 132, and insert 12 may include at least a first plurality of openings 136. To adjust the depth control, insert 12 may be translated a desired amount until one opening of the first plurality of openings 136 is aligned with opening 132, and a pin 13 may be inserted into the aligned openings to maintain the selected length. In one embodiment, roller guide 11 may include a pair of openings 132 on opposite sides of guide, insert 12 may include a second plurality of openings on an opposite side of the first plurality of openings 136, and pin 13 may have a length configured to pass through all aligned openings.

Guide 11 also may include a collar 134 proximate opening for receiving insert 12. Collar may have a perimeter sized substantially similar to insert perimeter, which may allow collar to guide and maintain alignment of insert 12, as well as minimize debris invading space between guide 11 and insert 12. Conversely, guide 11 may include one or more mounting ears 127 on an end opposite collar 134. Preferably, each guide 11 includes a plurality of mounting ears 127. Similarly, underside of attachment plate 2 may include a respective plurality of mounting ears 20 having a distance between them configured to receive mounting ears 127 on one of guides 11, with a similar plurality of ears 20 configured to receive mounting ears 127 on a second guide 11. Mounting ears 20 may be disposed on attachment plate proximate an upper end, i.e., generally opposite flange 34. Pin 14 may pass through mounting ears 20, 127, thereby releasably securing guide 11 to attachment plate 2, while still allowing guide 11 to pivot relative to attachment plate 2.

If the operator knows how thick each curb portion to be removed is, he may preset a length of insert 12 prior to removing any curb sections. Insert 12 may include a scale along one or more of its sides corresponding to curb depth. When the insert displays a distance corresponding to the curb depth or, if no match, the next distance larger than the curb depth, the operator may insert pin 13 to set the insert depth.

Alternatively, because sequential curb segments often have substantially the same thickness, the operator may drive fork 3 under a first segment without setting the depth of insert 12. Once wear bar 6 abuts an underside of the first segment, the operator or another person may adjust the insert 12 to a proper depth, which then may be used for each successive segment to be removed.

Turning to FIGS. 1-2 and 5-6, curber 1 may include one or more pistons or rams such as hydraulic ram cylinders 7 for further articulation of roller 17. Like guides 11, pistons 7 may be releasably coupled to and/or operatively engaged with both attachment plate 2 and roller shaft 16. Additionally, like guides 11, curber 1 may include a plurality of pistons 7, such as one piston connected to each end of roller shaft 16. Guides 11 may be disposed proximate ends of roller 17, and pistons 7 may be disposed generally coplanar with guides 11. Additionally, curber 1 may contain a bearing or washer outward from roller 17 and/or guides 11 and/or pistons 7, proximate ends of roller shaft 16.

Proximal end 60 of piston 7 may include one or more mounting ears 62 with openings or eyelets 63. Similar to mounting ears 20, curber may include one or more lower mounting ears 19 integrally formed in, mounted on, e.g., via welding, or otherwise secured to attachment plate. As seen in FIG. 2, a single mounting ear 19 on attachment plate may couple to one or more mounting ears 62 on each piston 7. As such, mounting ear 19 may have a width slightly smaller than width between mounting ears 62 to avoid frictional rubbing between mounting ear 19 and mounting ears 62 while also minimizing lateral “play” in the connection. In addition, because a single mounting ear 19 may be employed, the ear 19 may include a longer base portion extending along and contacting attachment plate 2. In the case of attachment to plate 2, this longer base portion may provide a larger perimeter for welding, the opportunity to add additional fasteners between ear 19 and plate 2, or other types of increased attachment. Ear 19 may include opening 138, and curber 1 may include pin 15 configured to pass through opening 138 and openings 63 to securely, but releasably couple piston 7 to attachment plate.

Like proximal end 60, distal end 64 of piston 7 may include one or more openings or eyelets 21. Eyelet 21 may be configured to receive roller shaft 16, while still allowing for rotation of piston 7 and shaft 16 relative to one another.

Instead of a roller, curber 1 may include one or more feet for contacting upper portion of curb at one or more discrete locations along the length of curb. For example, instead of roller 17 spanning a width between guides 11 with inserts 12, distal ends 137 of inserts may include or be coupled to feet. Similar to adjustability of roller 17 on shaft 16, feet may be adjustable via translation of inserts 12 and movement of pistons 7. Both roller 17 and feet may be considered curb restrainers since, when combined with wear bar 6, they may hold curb and restrain its ability to move or become loose. In addition, other types of curb restrainers are possible, provided they provide a compressive force against the upper portion of the curb segment.

Returning to FIGS. 1-4, curber 1 may include one or more covers over pistons 7 such as lower ram cylinder cover 8 and upper ram cylinder cover 9. Covers 8, 9 may be disposed proximate undersides of pistons 7, i.e., on a side generally opposite from side facing attachment plate 2. Covers 8, 9 may substantially span a width of curber 1 so that each cover 8, 9 provides at least partial protection for each piston 7 and system components disposed between pistons. Covers 8, 9 may combine to shield pistons 7 and hydraulic pressure regulator 18 (including hoses) from potential damage caused by debris, e.g., if curb cracks upward, if fork 3 is lowered too far into ground, or if roller guide insert 12 and/or piston 7 are extended too far for a curb portion being removed.

Lower cover 8 may be generally planar and may be fixed or otherwise generally immovable with respect to proximal ends 60 of pistons 7. For example, lower cover 8 may have a plurality of openings 78 configured to receive a plurality of fasteners 80, and fasteners 80 may couple directly or indirectly to piston proximal ends 60.

Similarly, upper cover 9 may be generally planar and may be fixed or otherwise generally immovable with respect to distal ends 64 of pistons 7. Like lower cover 8, upper cover 9 may include a plurality of fasteners to couple cover 9 directly or indirectly to distal ends 64. Alternatively, as seen in FIG. 2, cover 9 may include a plurality of mounting brackets 10 extending away from cover 9. Each mounting bracket 10 may include openings 82, which may be generally perpendicular to cover 9 and/or generally parallel to roller 17. Additionally, openings 82 may be configured to receive roller 17. Instead of using fasteners 80, lower cover 8 may include similar mounting brackets, e.g., located and configured to receive pins 15 that secure pistons 7 to mounting ears 19.

While covers 8, 9 may be generally immovable with respect to proximal and distal ends of pistons 7, respectively, covers 8, 9 may allow for movement relative to one another, i.e., covers 8, 9 may translate relative to one another as piston shaft extends or retracts. Covers 8, 9 may include one or more flanges 84, which may assist in maintaining alignment of covers 8, 9 relative to one another. As seen in FIG. 2, a plurality of flanges 84 are disposed on cover 9, although one or more flanges 84 may be disposed on cover 8, in addition to or instead of locating flanges on cover 9. Flanges 84 may form a gap, and when flanges are disposed on cover 9, a portion of cover 8 may be disposed within gap. The gap may be sized slightly larger than a thickness of cover 8, so as to permit sliding of cover 8 relative to cover 9.

Pistons/ram 7 may connect to skid steer hydraulics via pressure regulator 18. Pressure regulator 18 may be operatively coupled to attachment plate 2, either directly or indirectly. For example, one or more fasteners 86 may pass through regulator housing and attachment plate 2. Alternatively, curber 1 may include a regulator mount 24. Mount 24 may be coupled to fork 3 and/or support bracket 23, e.g., via welding. If curber 1 includes a single fork 3, fork 3 ideally may be substantially centered on attachment plate 2 and, as such, regulator 18 also may be substantially centered on attachment plate 2.

Hoses of pressure regulator 18 may extend outward from mount 24 and may removably couple to pistons 7 and to skid steer supply lines in order to control extension and retraction of pistons. Hydraulics may be configured to extend and retract each piston generally equally or at substantially the same time, e.g., the same line may control both pressure and release for multiple pistons.

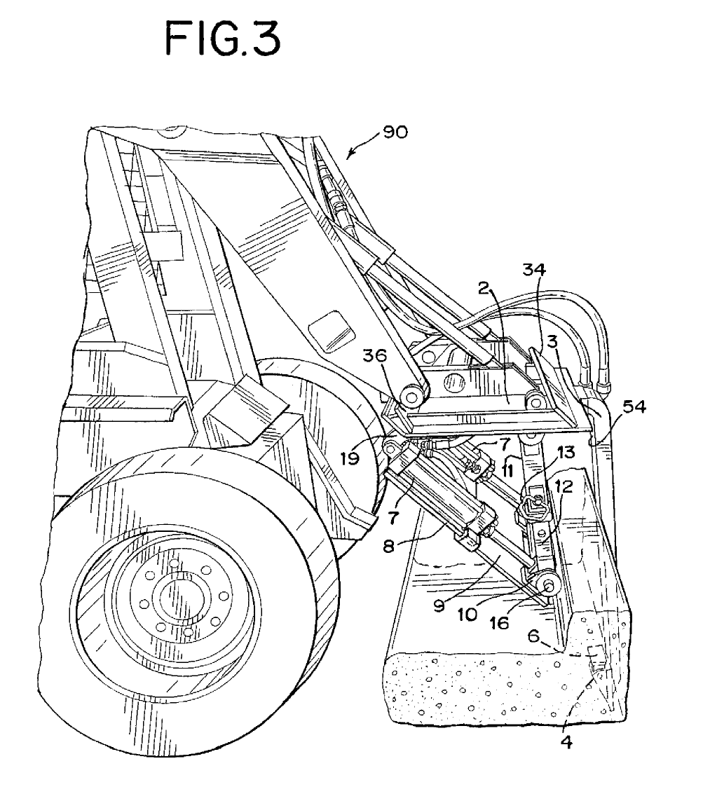

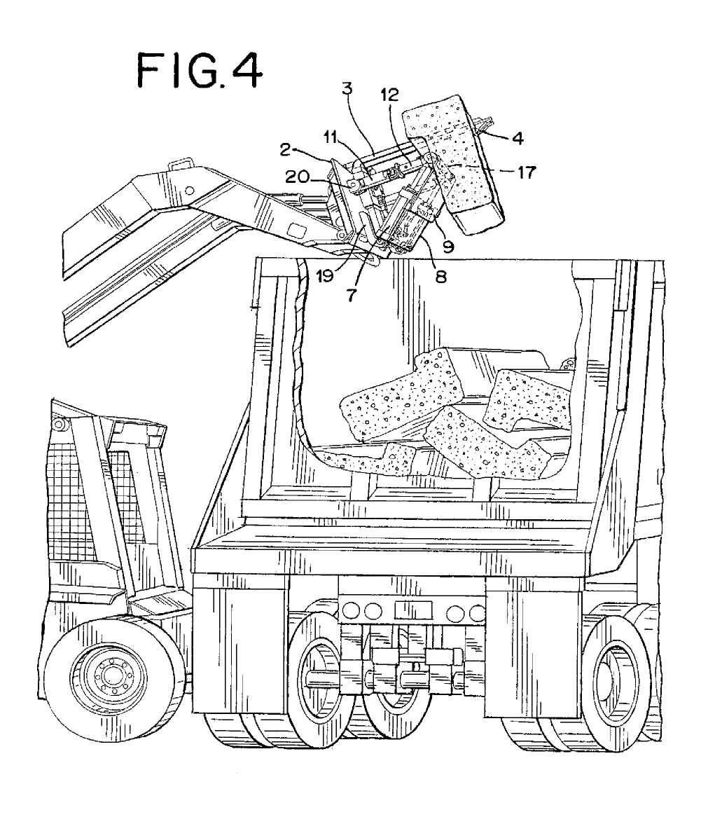

As seen in FIG. 3, curber 1 may be connected to skid steer 90 or other equipment so that attachment plate 2 is generally parallel to the ground and forks 3 extend generally downward toward ground when skid steer 90 is in a dumping configuration, i.e., where end arm of skid steer 90 is generally horizontal/level with ground. Once the curb segment is removed from the ground, the skid steer end arm may be retracted, rotating curber 1 and the curb segment upward. This configuration may allow the curber 1 and segment to be lifted higher off the ground than when in the dumping configuration. Higher clearance may be beneficial when lifting curber and segment, such as when loading segment into a bin hauled by a semi truck. As seen in FIG. 4, once the curber 1 and segment clear the upper edge of the bin, curber 1 may be rotated back to the dumping position, which may decrease the distance the segment falls when released. In addition, it may cause the segment to be more level when released, which may reduce the occurrence of cracked and/or broken segments.

Curber 1 may be used to remove a sequence of curb segments while causing minimal damage to the area surrounding the curb. Preferably, segments may be saw-cut into predetermined lengths or ranges of length, e.g., by cutting at predetermined or desired lengths, e.g., by cutting every about 4 to about 10 feet. In addition, a seam between the curb and the street also may be saw-cut, so that the curb segment preferably is completely separated from the surrounding concrete. The curber 1 may travel along the paved street and may be maneuvered into a position facing the curb. As such, curber 1 may remain on paved ground before, during, and after the removal process, minimizing or eliminating disturbances to unpaved or landscaped areas such as the parkway between the curb and a sidewalk.

After segment is cut to separate it from its adjoining segments, curber 1 may be disposed over segment. Fork 3 (or forks, if more than one is used) may be lowered into the ground behind the curb segment. Fork 3 may be lowered substantially vertically or, preferably, fork 3 may be moved toward curb segment as it is lowered. For example, user may reverse skid steer slightly as fork 3 is lowered into the ground. Because fork 3 may be inclined rather than normal to the ground, this may serve two functions. First, it may minimize the size of the hole formed by fork as compared to if an angled fork were lowered straight down without moving skid steer. In addition, it may aid in locating wear bar 6 underneath curb segment.

Alternatively, the user may lower fork 3 down until it reaches a depth greater than curb depth. This may create a larger hole than in the instance described above, although this hole still may be relatively minor as compared to other curb removal efforts and also may be easily repaired.

In any event, once fork 3 is driven to a depth greater than curb depth, operator may reverse skid steer to position wear bar 6 underneath curb segment. Fork 3, then may be raised slightly to separate curb segment from foundation, e.g., releasing vacuum pressure that may exist between curb segment and foundation. Prior to, or after, raising fork 3, roller 17 or other curb restrainer may be positioned against upper side of curb. This may include releasing pin 13, adjusting the length of roller guide 11 with insert 12, and reinserting pin 13 once the desired length is achieved. Additionally—or alternatively, if insert 12 already is adjusted to a desired length—this may include operating skid steer hydraulic controls to extend piston 7 and rotate roller 17 into a desired position, preferably in the curve between the generally horizontal and generally vertical curb portions.

Once the curb restrainer is in place, the curb segment may be held on both its underside and upper surfaces. Curber 1 and segment then may be raised substantially vertically until the segment and fork 3 with wear bar holder 4 are clear of the newly-formed hole. Skid steer then may driven to a location for dumping the removed segment, e.g., alongside a dump truck, semi truck with dumping bin, flatbed truck, or other vehicle, as seen in FIG. 4. Curber 1 may be raised to clear an upper edge of the vehicle's storage area, which may include rotating the end arm of the skid steer and the attached curber upward. Once cleared, curber 1 may be rotated back to the initial dumping configuration. In either event, to release the curb segment, pistons 7 may be retracted, moving curb restrainer away from curb segment, releasing curber's grip on the segment.

Once the segment is deposited, skid steer 90 may return to the curb and remove another segment, preferably the next segment in line, although any segment that has been saw cut to separate it from the adjacent curb segments and the street may be removed.

Removing each segment may result in leaving a hole substantially the same size as the segment and a plurality of small holes corresponding to the number of forks 3. In this case, preparing the area for a new section of curb may be simplified greatly, as the only landscaping that may be required may be to fill the small holes formed by fork 3.

As discussed above, curber 1 may allow a user to remove curb segments while keeping those segments substantially intact. As such, curb segments may be loaded into a bin or truck bed, e.g., and transported intact to another site. At that second location, curber 1 or additional equipment may be used to lift curbs and use them for another purpose. For example, removed curb segments may be used to form a new curb, e.g., in cases where a rough curb may be needed prior to pouring a new curb. Other exemplary uses for curb segments may include forming retaining walls or installing segments as part of a system for erosion control.

While the foregoing written description of the invention enables one of ordinary skill to make and use what is considered presently to be the best mode thereof, those of ordinary skill will understand and appreciate the existence of variations, combinations, and equivalents of the specific exemplary embodiments and methods herein. The invention should therefore not be limited by the above described embodiments and methods, but by all embodiments and methods within the scope and spirit of the invention as claimed.

What is claimed is:

1. An apparatus for removing a curb segment, comprising:
a base portion releasably coupled to a portable transportation device;
a fork extending generally downward from said base portion, said fork having a distal end;
a bearing surface proximate said distal end of said fork, said bearing surface configured to engage an underside of said curb segment;
a curb restrainer configured to engage an upper side of said curb segment; and
a hydraulic system configured to position said curb restrainer.

2. An apparatus according to claim 1,
wherein said portable transportation device is a skid steer.

3. An apparatus according to claim 1,
wherein said hydraulic system operatively couples to a hydraulic system of said portable transportation system.

4. An apparatus according to claim 1, further comprising:
at least one translatable guide operatively coupled to said base portion and said curb restrainer; and
at least one piston also operatively coupled to said base portion and said curb restrainer.

5. An apparatus according to claim 4, further comprising:
a plurality of translatable guides operatively coupled to said base portion and said curb restrainer; and
a plurality of pistons also operatively coupled to said base portion and said curb restrainer.

6. An apparatus according to claim 4,
wherein said translatable guide comprises a base portion and an insert, said insert adjustable among a plurality of discrete positions.

7. An apparatus according to claim 4,
wherein said curb restrainer comprises a roller.

8. An attachment for a skid steer, comprising:
an attachment plate configured to couple to said skid steer;
at least one fork extending generally downward from said attachment plate;
at least one bearing surface proximate a distal end of said at least one fork;
at least one tapered tine proximate a distal end of said at least one fork; and
a telescoping curb restrainer rotatably, operatively coupled to said attachment plate.

9. An attachment for a skid steer according to claim 8,
wherein said curb restrainer is coupled to at least one piston, said at least one piston operatively coupled to said attachment plate;
wherein said curb restrainer also is coupled to at least one telescoping guide, said at least one telescoping guide operatively coupled to said attachment plate.

10. An attachment for a skid steer according to claim 9,
wherein said at least one piston and said at least one telescoping guide are rotatable with respect to said attachment plate.

11. An attachment for a skid steer according to claim 8, further comprising:
a hydraulic system operatively coupled to said telescoping curb restrainer.

12. An attachment for a skid steer according to claim 11, further comprising:
a first cover; and
a second cover disposed proximate said first cover;
wherein said first cover and said second cover overlap;
and further wherein said first cover moves relative to said second cover when said hydraulic system extends and retracts said telescoping curb restrainer.

13. An attachment for a skid steer according to claim 8,
wherein said at least one bearing surface is releasably coupled to said at least one fork.

14. An attachment for a skid steer according to claim 8, further comprising:
at least one holder proximate said distal end said at least one fork, said at least one holder configured to hold at least one wear bar, wherein said at least one wear bar comprises said at least one bearing surface.

15. An attachment for a skid steer according to claim 14,
said at least one wear bar including at least one prong, and said at least one holder including at least one recess configured to receive said at least one prong.

16. An apparatus for removing a curb segment, comprising:
a fork having a proximal end and a tapered, distal end;
a wear bar having a bearing surface, said bearing surface substantially perpendicular to said fork;
a wear bar holder proximate said distal end of said fork;
a telescoping and rotating curb restrainer; and
a hydraulic ram coupled to said curb restrainer;
wherein said wear bar includes a prong and said wear bar holder includes a recess configured to receive said prong.

17. An apparatus according to claim 16,
wherein said wear bar holder includes at least one tine extending below said distal end of said fork.

18. An apparatus according to claim 16,
wherein said tine tapers from proximate said bearing surface toward a distal end of said tine.

19. An apparatus according to claim 16,
wherein said curb restrainer comprises a roller.

20. An apparatus according to claim 16, further comprising:
a second hydraulic ram coupled to said curb restrainer,
wherein said curb restrainer comprises a roller mounted on a shaft,
and further wherein said hydraulic ram and said second hydraulic ram couple to said shaft proximate opposite ends of said roller.
